(19) United States
(12) Patent Application Publication
(10) Pub. No.: US 2026/0299870 A1
(43) Pub. Date: Oct. 1, 2026

(54) PORT FOR A COMPUTING DEVICE

(71) Applicant: GOOGLE LLC, Mountain View, CA (US)

(72) Inventors: Joshua Moore, Elora (CA); Craig Eric Ranta, Kitchener (CA)

(21) Appl. No.: 19/481,117

(22) PCT Filed: May 31, 2023
(86) PCT No.: PCT/US2023/067666

§ 371 Date: Nov. 3, 2025

(51) Int. Cl. G06F 3/16; G06F 13/20; H04R 1/02

(52) U.S. Cl. CPC G06F 3/162; G06F 13/20; H04R 1/023; H04R 2499/15

(57) ABSTRACT

A port is provided in a housing of a computing device. The port uses a common installation volume in the housing to provide the functionality of a first component and a second component in a single, combined port. The port functions as an audio output port in a first mode, and as a charging and/or data communication port in a second mode. A front volume of an audio output device extends between an audio driver and a receptacle of the port for output of audio content via the receptacle in the first mode. An interface device may be provided in a void defined by a wall portion of the receptacle, to facilitate connection with a charging plug selectively insertable into the receptacle for charging of the computing device and/or wired data communication in the second mode.

### FIELD

This relates, generally, to connection ports of computing devices.

### BACKGROUND

Computing devices typically include various types of interface devices providing for input and output of information to a user, various types of interface ports providing for communication with other electronic devices, charging and the like, and other such features. In some computing devices, volume for accommodating electronic components, interface ports, interface devices and the like may be somewhat constrained due to, for example, form factor, accessibility considerations, aesthetic considerations, and the like.

### SUMMARY

A computing device, in accordance with implementations described herein, includes a port. In some examples, port is a combination port, or a multi-functional port. In some examples, the port incorporates the functionality of multiple devices and/or multiple ports of a computing device. In some examples, the port combines the functionality of a user interface device and an interface port. In some examples, the port combines the functionality of an audio output port and the functionality of a charging port and/or a data communication port. In some examples, the port is incorporated into a computing device in the form of a head mounted display device. In some examples, the combination port is incorporated into other types of computing devices.

In a general aspect, a computing device includes a housing, and a port provided in the housing, the port including a receptacle accessible from an outside of the housing. In some examples, the receptacle includes an audio output portion in communication with an audio driver received in the housing; and an interface portion configured to removably receive a plug of an external cable, the interface portion including at least one interface device. In a first mode, the first portion of the port is configured to output audio content generated by the audio driver. In a second mode, the interface portion of the port is configured to provide for at least one of charging of a power storage device received in the housing via the plug of the external cable received in the receptacle, or exchange of data with an external device via the plug of the external cable received in the receptacle.

In accordance with implementations described herein, a computing device may include a port combining the functionality of an output port for outputting, in a first mode of the port, a signal without a cable being connected to the combination port, with the functionality of an interface port for, in a second mode of the port, receiving a signal and/or energy via a cable connected to the port. In a first mode of the port, the port may thus output a signal, for example relating to or including audio content or an infrared signal, to an environment surrounding the port independent from a cable being connected to the combination port. In a second mode of the port the port may function as a cable interface to receive at least one signal and/or energy via a cable plugged with its plug end to the port. In some examples, in the second mode, the port may include the functionality of an interface port that incorporates the functionality of a charging port into which a plug end of a charging cable is received for charging a power storage device of computing device.

A port, in accordance with implementations described herein, may be a combination port, or a multi-functional port, that provides for efficient and effective placement of components of a computing device in which the port is incorporated. The efficient placement of components afforded by the port is particularly effective in addressing volume constraints associated with computing devices having somewhat restrictive form factors.

The details of one or more implementations are set forth in the accompanying drawings and the description below. Other features will be apparent from the description and drawings, and from the claims.

### BRIEF DESCRIPTION OF THE DRAWINGS

FIG. 1A illustrates example computing devices.

FIG. 1B is a front view of an example computing device shown in FIG. 1A.

FIG. 1C is a rear view of the example computing device shown in FIG. 1B.

FIG. 1D is a perspective view of the example computing device shown in FIGS. 1B and 1C.

FIG. 1E is a block diagram of the example computing device shown in FIGS. 1B-1D.

FIG. 2A is a close-in view of an area A of an example computing device shown in FIG. 1D.

FIGS. 2B and 2C are side views, corresponding to the side view shown in FIG. 2A, illustrating components received in an arm portion of the example computing device.

FIG. 3A is a bottom view of the example arm portion shown in FIG. 2A.

FIG. 3B is a bottom view, corresponding to the bottom view shown in FIG. 3A, illustrating components received in the arm portion of the example computing device.

FIG. 4 is a flowchart of an example method.

### DETAILED DESCRIPTION

In some computing devices, installation volume for accommodating electronic components, interface ports, interface devices and the like can be constrained due to various factors, for example, a form factor associated with the computing device, the need for installation of some components in/on specific portions of the computing device, user accessibility considerations, aesthetic considerations, and the like. For example, the form factor and associated installation volume of a computing device in the form of a head mounted wearable device, or smart glasses, may pose challenges in accommodating all of the components of the smart glasses in and/or on the installation volume defined by the frame. The need for placement of some components in and/or on specific portions of the frame may further complicate the accommodation of these components within the available installation volume. In the example of a head mounted wearable device, or smart glasses, functionality of certain components such as, for example, a display device, a gaze tracking device, speakers, microphones, and the like, may dictate specific placement of those in and/or on the installation volume defined by the frame to provide the desired functionality.

A combination port, in accordance with implementations described herein, is incorporated into an example computing device to provide for combined functionality in a shared installation volume. Such a combination port provides for efficient and effective use of limited installation volume available in a computing device.

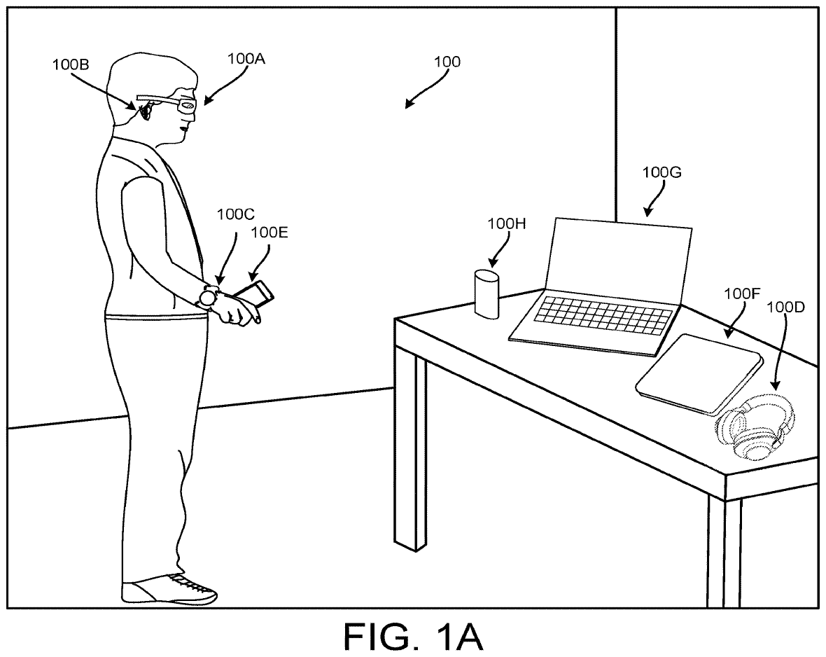

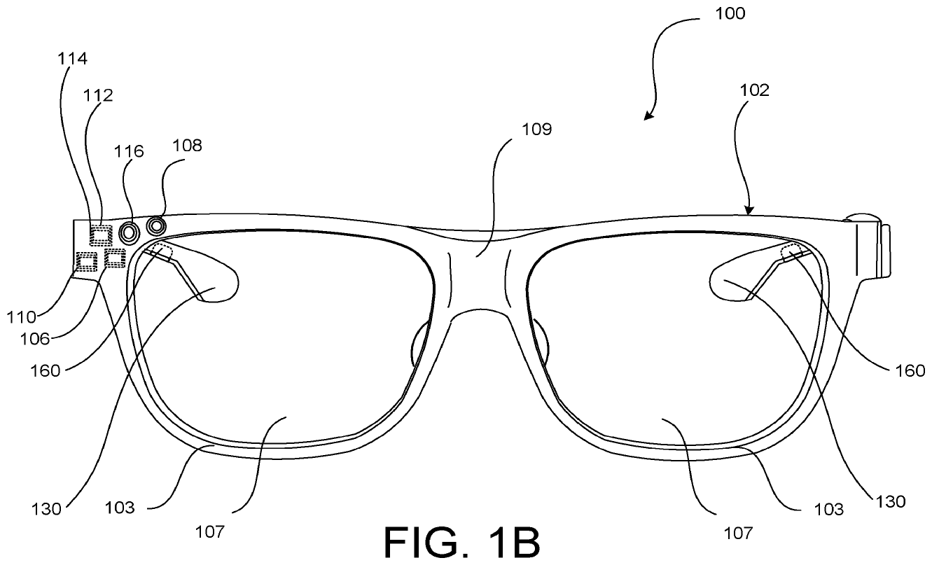

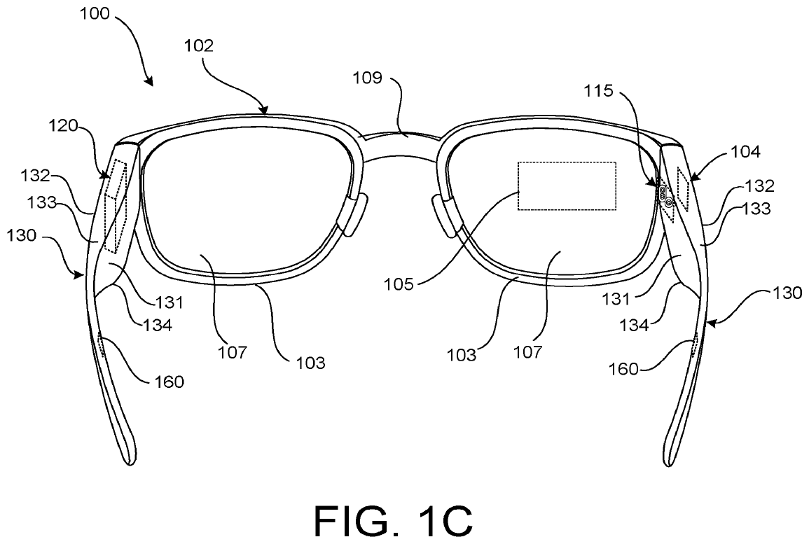

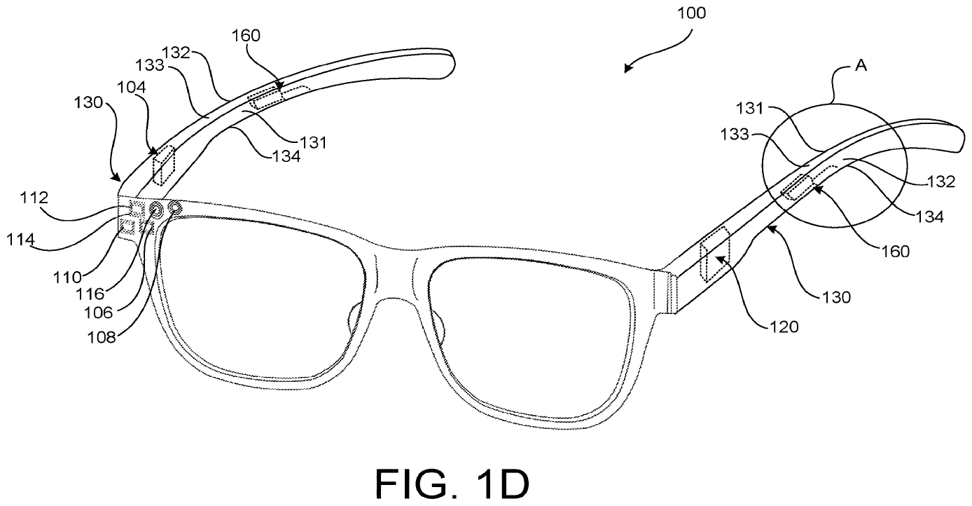

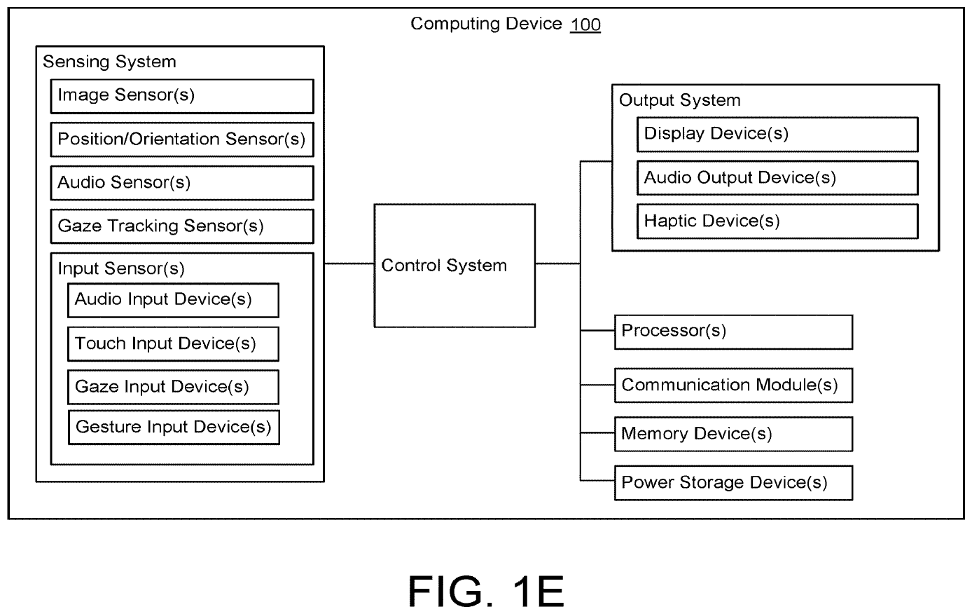

FIG. 1A illustrates some example computing devices 100, into which a combination port, in accordance with implementations described herein, can be incorporated, simply for purposes of discussion and illustration. Some of the example computing devices 100 shown in FIG. 1A are wearable computing devices. For example, FIG. 1A illustrates a first example computing device 100A, in the form of a head mounted computing device such as, for example, goggles or smart glasses, worn by a user. FIG. 1A illustrates a second example computing device 100B in the form of an ear worn computing device, such as, for example, ear buds, worn by the user. FIG. 1A illustrates a third example computing device 100C in the form of a wrist worn computing device, such as, for example, a smart band or smart watch, worn by the user. FIG. 1A illustrates a fourth example computing device 100D in the form of a head and/or ear mounted computing device, such as, for example, headphones. FIG. 1A illustrates a fifth example computing device 100E in the form of a mobile handheld computing device such as, for example, a smart phone. FIG. 1A illustrates a sixth example computing device 100F in the form of a mobile and/or handheld computing device such as, for example, a tablet computing device. FIG. 1A illustrates a seventh example computing device 100G in the form of a mobile computing device such as, for example, a laptop computing device. FIG. 1A illustrates an eighth example computing device 100H in the form of a smart speaker. FIG. 1A illustrates just some example computing devices 100 into which a combination port could be incorporated. The principles to be described herein can be applied to interface device(s)/interface port(s) of other computing devices not specifically shown in FIG. 1A.

In some situations, installation space, or volume, available to accommodate functional components may be constrained due to, for example, the form factor associated with some computing devices, the arrangement of internal components driven by functionality associated with the form factor, user accessibility, and the like, aesthetics, and other such factors. For example, the form factor associated with some wearable computing devices may complicate the accommodation of various components within the computing device. Additionally, the form factor, coupled with the particular use requirements and use scenarios associated with these types of wearable computing devices, tends to constrain and/or dictate the placement, or installation location or position of at least some components in and/or on the computing device.

FIGS. 1B-1D illustrate features of one of the example computing devices 100, in particular, the first example computing device 100A in the form of the head mounted wearable device, or smart glasses, shown in FIG. 1A. FIG. 1B is a front view, FIG. 1C is a rear view, and FIG. 1D is a perspective view of the example computing device 100, in the form of the head mounted wearable device shown in FIG. 1A. FIG. 1E is a block diagram of the example computing device 100 shown in FIGS. 1B-1D. The features of the example computing device 100 to be described with respect to FIGS. 1B-1E are presented for purposes of discussion and illustration. The principles to be described herein can be applied to a computing device including more, or fewer features and/or different combinations of features than described herein.

In some examples, a form factor associated with the example computing devices 100, may pose challenges in accommodating all of the components within the installation volume defined by a structure, or housing, or enclosure, or frame of the computing device 100. For example, the form factor and associated installation volume of the example computing device 100 in the form of the example head mounted wearable device, or smart glasses, may pose challenges in accommodating all of the components of the computing device 100 in and/or on the installation volume defined by a frame of the example computing device 100. In some situations, the need for placement of components in or on specific portions of the example computing device 100 may further complicate the accommodation of all of the components in and/or on the available installation volume. For example, in a computing device 100 in the form of the example head mounted wearable device, or smart glasses, functionality of certain devices may dictate placement of components associated with these devices in and/or on the installation volume defined by the frame to provide the desired functionality. Other considerations, such as, for example, available space, distribution of weight, distribution of heat generating components, user comfort, and the like may somewhat limit placement of components.

In some examples, a combination port, in accordance with implementations described herein, is incorporated into the example computing devices 100 shown in FIG. 1A. The incorporation of a combination port provides for combined functionality in a shared installation volume, thus providing for efficient and effective use of the limited installation volume available in the computing device. In some examples, a combination port, in accordance with implementations described herein, combines functionality of components that share little to no common operational time, so that the combined functionality does not limit operability of the computing device 100.

Hereinafter, a combination port, in accordance with implementations described herein, will be described with respect to incorporation into a computing device in the form of a head mounted wearable device, or smart glasses, simply for purposes of discussion and illustration. The principles to be described herein are applicable to incorporation of combination ports into other computing devices, including the example computing devices 100 shown in FIG. 1A, and other computing devices not explicitly described herein.

The computing device 100, in the form of the example head mounted wearable device as shown in FIGS. 1B-1D, includes a frame 102 including rim portions 103 surrounding glass portions, or lenses 107. In some examples, the lenses 107 may be corrective/prescription lenses. In some examples, the lenses 107 may be glass portions that do not necessarily incorporate corrective/prescription parameters. In some examples, a bridge portion 109 connects the rim portions 103 of the frame 102. An arm portion 130 is coupled, for example, rotatably coupled, to each rim portion 103. In some examples, the frame 102, including the rim portions 103, the bridge portion 109, and the arm portions 130 define a housing of the example computing device 100, in which components of the example computing device are received. In some examples, one or both of the rim portions 103 defines a housing of the example computing device 100 in which components can be received. In some examples, one or both of the arm portions 130 defines a housing of the example computing device 100 in which components can be received.

The example computing device 100, in the form of the head mounted wearable device, or smart glasses, as shown in FIGS. 1B-1D, includes a display device 104, an audio input device 106, or microphone, an illumination device 108, a sensing system 110, a control system 112, at least one processor 114, and an outward facing image sensor 116 (for example, a camera). In some examples, the sensing system 110 includes various sensing devices, and the control system 112 includes various control system devices including, for example, the at least one processor 114 operably coupled to the components of the control system 112.

In some examples, the display device 104 outputs visual content, under the control of the control system 112, for example, at an output coupler 105, so that the visual content is visible to the user. In the example shown in FIGS. 1B-1D, the display device 104 is provided in one of the two arm portions 130, simply for purposes of discussion and illustration. Display devices 104 can be provided in each of the two arm portions 130 to provide for binocular output of content. In some examples, the display device 104 is a see-through near eye display. In some examples, the display device 104 is configured to project light from a display source onto a portion of teleprompter glass functioning as a beamsplitter seated at an angle (for example, 30-45 degrees, or other angle based on the overall configuration of the computing device 100). In some examples, the beamsplitter generates reflection and transmission values that allow light from the display device 104 to be partially reflected while remaining light is transmitted through the beamsplitter. In some examples, this type of optic design allows a user to see both physical items in the ambient environment, for example, through the lenses 107, together with content (for example, digital images, user interface elements, virtual content, and the like) output by the display device 104. In some examples, waveguide optics may be used to depict content by the display device 104.

In some examples, the audio input device 106 detects audio signals, for processing by the at least one processor 114 as an audio input command for execution by the control system 112. In some examples, image data detected by the image sensor 116 may be processed by the at least one processor 114 for the detection of gesture inputs to be executed by the control system 112. In some examples, touch inputs detected, for example by position/orientation sensor(s) of the sensing system 110 and/or at a touch sensitive surface (not shown in FIGS. 1B-1D) of the frame 102 may be processed by the at least one processor 114 as a touch input command for execution by the control system 112.

In some examples, the computing device 100 includes a gaze tracking device 115 to detect and track eye gaze direction and movement. In some examples, data captured by the gaze tracking device 115 is processed by the at least one processor 114 to detect and track gaze direction and movement as a user input for execution by the control system 112. In the example shown in FIGS. 1B-ID, the gaze tracking device 115 is provided in one of the two arm portions 130, simply for purposes of discussion and illustration. In the example arrangement shown in FIGS. 1B-1D, the gaze tracking device 115 is provided in the same arm portion 130 as the display device 104, so that user eye gaze can be tracked not only with respect to objects in the physical environment, but also with respect to the content output for display by the display device 104. In some examples, a gaze tracking device 115 is provided in each of the two arm portions 130 to provide for gaze tracking of each of the two eyes of the user. In some examples, a display device 104 is provided in each of the two arm portions 130 to provide for binocular display of visual content.

The example computing device 100, in the form of the head mounted computing device, or smart glasses, as shown in FIGS. 1B-1D, includes an audio output device 160 (such as, for example, one or more speakers). In the example arrangement shown in FIGS. 1B-1D, an audio output device 160, or speaker, is provided in a housing defined by each of the two arm portions 130 of the frame 102. In the example arrangement shown in FIGS. 1B-1D, an output port of the audio output device 160 is positioned on a lower edge portion of each of the arm portions 130. In the example arrangement shown in FIGS. 1B-1D, the output port of the audio output device 160 is positioned at a transitional portion of the arm portion 130, as the contour of the arm portion 130 changes to accommodate a fit of the arm portion 130 on the ear saddle point of the user, so that sound output through the output port of the audio output device 160 is oriented toward the ear, and in particular, toward the ear canal of the user.

In some examples, the computing device 100 includes a power storage device 120, such as, for example, a battery, that provides power to the components of the computing device 100. In the example shown in FIGS. 1B-1D, the power storage device 120 is included in a housing defined by one of the arm portions 130, simply for purposes of discussion and illustration. The principles to be described herein can be applied to a computing device including more than one power storage device, arranged similarly or differently than shown in FIGS. 1B-1D.

In some examples, the display device 104, the audio output device 160, haptic devices (not shown in FIGS. 1B-1D), and other such devices, form an output system of the computing device 100. In some examples, the audio input device 106, the gaze tracking device 115, the image sensor 116/gesture input device, the touch input device, and other such devices form an input system of the computing device 100. In some examples, one or more communication modules (not shown in FIGS. 1B-1D) provide for communication and exchange of information between the computing device 100 and other external devices. In some examples, one or more memory devices are accessible to the at least one processor 114 and the control system 112 for local storage of information.

In some examples, a combination port, in accordance with implementations described herein, is incorporated into the example computing device 100, in the form of the head mounted wearable device, or smart glasses described with respect to FIGS. 1B-1E, to provide for combined functionality in a shared installation volume, thus providing for efficient and effective use of limited installation volume available in and/or on the frame 102. In some examples, a combination port, in accordance with implementations described herein, is operable in a first mode and in a second mode. In the first mode, the combination port may be operable as an audio output port that outputs audio content generated by an audio output device of the example computing device 100. In the second mode, the combination port may be operable as at least one of a charging port or a data communication port in response to insertion of a plug of an external cable into the combination port. In the second mode, the combination port directs power, from the external cable and plug, through at least one interface device in the combination port, to the power storage device 120 of the example computing device 100. In the second mode, the combination port provides for exchange of data between the example computing device 100 and an external device, through the connection of the plug with at least one interface device in the combination port.

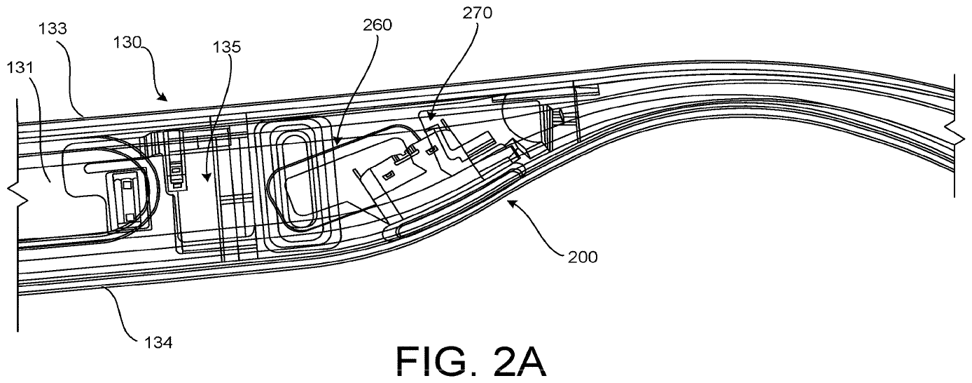

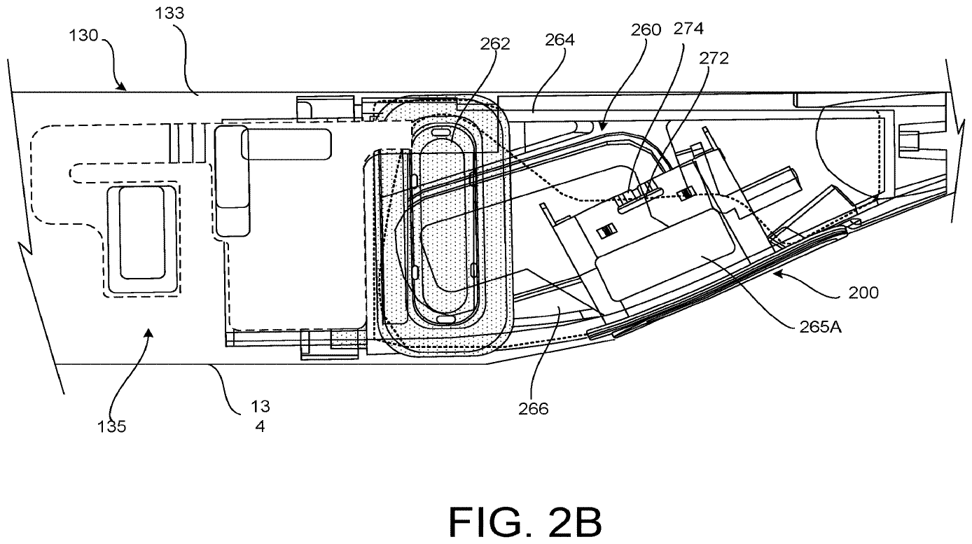

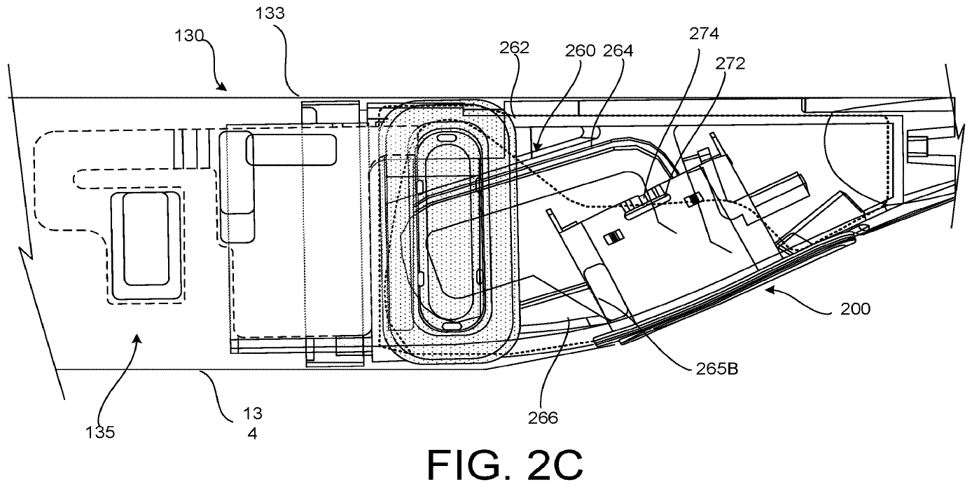

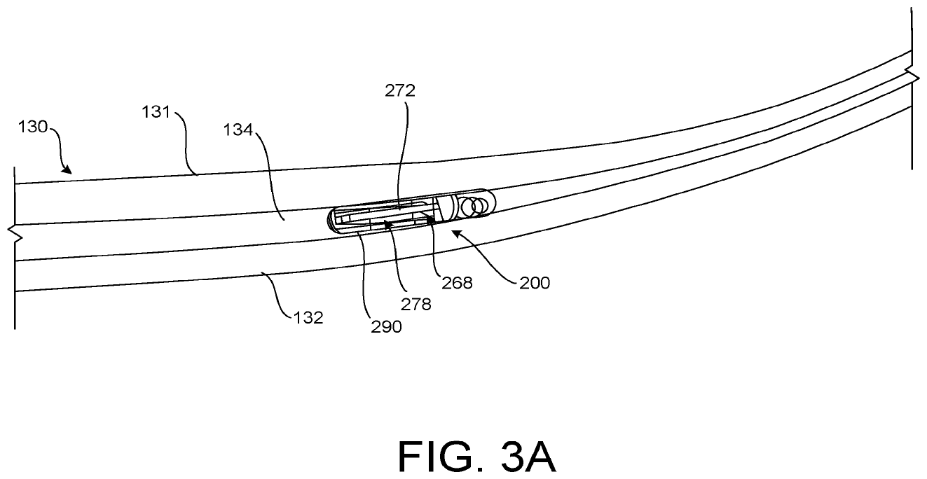

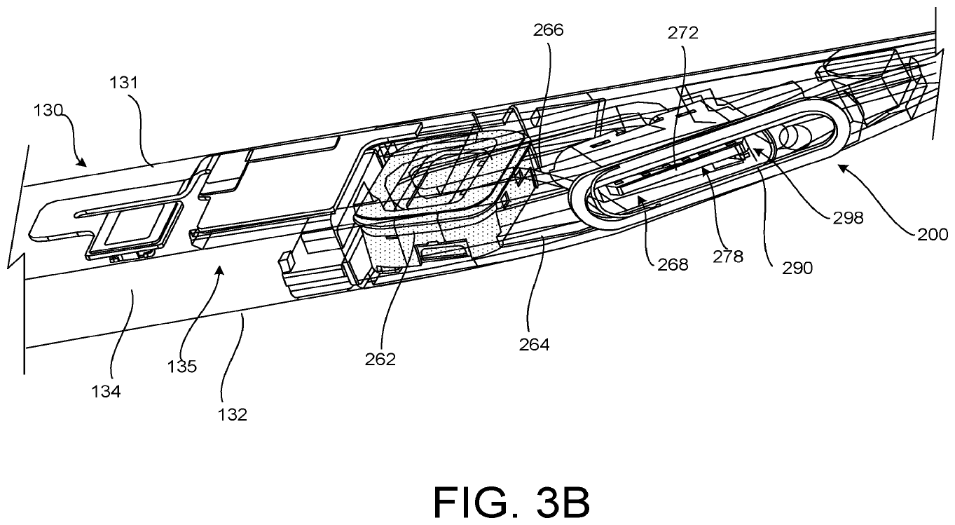

FIG. 2A is a close-in view of an area A shown in FIG. 1D. In particular, FIG. 2A is a close in, semi-transparent side view of a portion of one of the arm portions 130 of the example computing device 100, in an area of the arm portion 130 housing an audio output device and a charging device of the example computing device 100. FIGS. 2B and 2C are side views, corresponding to the side view shown in FIG. 2A, illustrating at least some of the components received in the arm portion 130 of the example computing device 100. FIG. 3A is a bottom view of the arm portion 130 of the computing device shown in FIG. 2A. FIG. 3B is a bottom view, corresponding to the bottom view shown in FIG. 3A, illustrating at least some of the components received in the arm portion 130 of the example computing device 100.

In the example shown in FIGS. 2A-3B, a combination port 200 is incorporated into the arm portion 130 of the example computing device 100, in the form of a head mounted wearable device, or smart glasses. In the example shown in FIGS. 2A-3B, the combination port 200 is a multi-functional port that makes use of a shared installation volume within a housing defined by the arm portion 130 of the example computing device 100, to combine the functionality of multiple components of the example computing device 100. In particular, in the example shown in FIGS. 2A-3B, the combination port 200 combines the functionality of an output port for outputting audio content generated by an audio output device in a first mode (without a cable being required to be connected to the combination port 200), with the functionality of an interface port, into which a plug end of a cable may be received for charging in a second mode. In some examples, in the second mode, the combination port may include the functionality of an interface port that incorporates the functionality of a charging port into which a plug end of a charging cable is received for charging of the power storage device 120 of the example computing device 100. In some examples, in the second mode, the combination port may include the functionality of an interface port that receives a plug end of a data cable that can provide for connection with an external device, for the exchange of data and/or information between the example computing device 100 and the external device. Hereinafter, the combination port 200 will be described in terms of a muti-functional port that combines the functionality of an audio output port with the functionality of an interface port that receives the plug end of a charging cable, for charging of the example computing device 100, for purposes of discussion and illustration. The principles to be described herein are applicable to combination ports, or multi-functional ports, incorporating the functionality of other combinations of components.

As noted above, the form factor associated with the example computing device 100 in the form of a head mounted wearable device, or smart glasses, constrains installation space available for components to be installed in and/or on the installation volume defined by the frame 102. Many of the components rely on power provided by, for example, the power storage device 120 for operation of the computing device 100. The power storage device 120, in turn, relies on replenishment of electrical power, typically provided from an external power source, connected to the computing device 100 via a charging cable inserted in a charging port of the computing device 100. Effective charging of the power storage device 120 is dependent on a high confidence, reliable, consistent connection between terminals of the plug end of an external cable and terminals within a charging port of the example computing device 100. Similarly, effective wired communication relies on high confidence, reliable consistent connection between terminals of the plug end of an external cable and terminals within a data communication port of the example computing device 100. In some examples, the example computing device 100 includes a single port that provides for charging and for wired data communication using a common cable. The use of existing, commonly configured cables and plugs may provide for these types of reliable, consistent connections with the example computing device 100. However, the use of existing, commonly configured cables and plugs for the charging of the power storage device 120 and/or for data communication may consume some of the already constrained installation volume available in the frame 102. When allocating space for components in the installation volume defined by the frame 102, it may be difficult to justify allocating some of this already constrained space to accommodate a port dedicated to a single function (charging and/or data communication), that is typically conducted when the computing device 100 is not in use.

In some examples, positioning of an audio output device in the arm portion 130 of the frame 102 allows sound generated by the audio output device to be directed out, through an audio output port formed in the arm portion 130 toward the ear, for example, the ear canal, of the user. The positioning of the audio output port on the arm portion 130 of the frame 102, the orientation of the audio output port relative to the ear/ear canal of the user, and other such features may facilitate the consumption of audio content by the user. In some examples, components associated with the audio output device may occupy a relatively large amount of space in the arm portion 130 of the frame 102. In many instances, an audio output device of the computing device 100 in the form of the head mounted wearable device, or smart glasses, is not in use while charging, and/or during wired data exchange. Thus, a combination port, or a multi-functional port, that provides for sharing of installation space, or installation volume, associated with the functionality of the output of audio content, and also with the functionality associated with charging and/or wired data communication, may provide for an efficient use of available installation space within the arm portion 130 of the frame 102, with little to no interference in use of these functions of the example computing device 100. That is, because there is little to no overlap in operational time during which audio content is consumed, and time during which the example computing device 100 is connected to an external cable for charging and/or wired data communication, combining these functionalities into a single port may allow for shared use of limited installation space, with little to no interference between outputting audio content and charging and/or wired data communication, and little to no inconvenience to the user. In some examples, a combination port, or a multi-functional port, providing for both the output of audio content and the charging of the example computing device 100 and/or wired data communication, may enhance the aesthetics of the computing device 100 by concealing the charging port/data communication port within the audio output port.

In the example orientation shown in FIGS. 1C and 1D, the arm portion 130 includes a first (side) portion 131, a second (side) portion 132, a third (upper) portion 133 and a fourth (lower) portion 134 defining a portion of the frame 102 corresponding to the arm portion 130. The first (side) portion 131, the second (side) portion 132, the third (upper) portion 133, and the fourth (lower) portion 134 define a housing having an interior space 135 in which components of the example computing device 100 can be received. In the example arrangement shown in FIGS. 2A-3B, a combination port 200 is incorporated into one of the arm portions 130 of the example computing device 100 shown in FIGS. 1B-1D. In this example arrangement, the combination port 200 is formed in the fourth (lower) portion 134 of one of the arm portions 130 of the example computing device 100. In this example arrangement, the combination port 200 is formed at a location along the lower portion 134 of the arm portion 130 at which audio content output via the combination port 200 is oriented toward the ear of the user, and in particular, is oriented toward the ear canal of the user, to facilitate the consumption of audio content by the user. In some examples, the combination port 200 includes an opening 290 formed in the outer surface of the arm portion 130 of the example computing device 100, the opening 290 defining a passage into a void defined within a receptacle 298 within the interior space 135 of the arm portion 130. In some examples, the receptacle 298 includes an audio output portion 268, and a terminal receiving portion 278. In some examples, the audio output portion 268 and the terminal receiving portion 278 share at least some common space within the receptacle 298. In some examples, the receptacle 298 is accessible, via the opening 290, from an outside of the example computing device 100. In some examples, the opening 290, the receptacle 298 and the void defined by the outer wall portion of the receptacle 298, are aligned, so as to convey audio content, generated by an audio output device, toward the ear of the user in the worn state of the example computing device 100 in the form of the head mounted wearable device, or smart glasses.

In the example shown in FIGS. 2A-3B, components of an audio output device 260 are incorporated into the arm portion 130 of the example computing device 100. The audio output device 260 shown in FIGS. 2A-3B may correspond to the audio output device 160 described above, and may include some, or all, of the features, and/or various combinations thereof, described above with respect to the audio output device 160.

In the example shown in FIGS. 2A-3B, the audio output device 260 includes a driver 262 installed in the interior space 135 formed within the arm portion 130. In some examples, a back volume 264 is coupled to the driver 262. In some examples, a front volume 266 is coupled to the driver 262. In some examples, the front volume 266 defines a channel that guides audio output signals, or sound, from the driver 262 toward the combination port 200. In particular, in some examples, the back volume 264 is separated from the front volume 266, and from the audio output portion 268 of the combination port 200, while the channel defined by the front volume 266 guides audio output signals, or sound, from the driver 262 for output from the arm portion 130 of the example computing device 100 via the audio output portion 268 of the combination port 200. In some examples, the audio output portion 268 of the combination port 200 is oriented so that audio content output via the audio output portion 268 of the combination port 200 is oriented toward the ear, and in particular, the ear canal, of the user to facilitate consumption of the audio content.

In some examples, a mesh 265A may be positioned at an interface between an open end portion of the channel defined by the front volume 266 and a corresponding opening in a wall portion of the receptacle 298, the mesh 265A extending across an open passage into the void defining the receptacle 298, as shown in FIG. 2B. In some examples, a mesh 265B may be positioned at an interface between an open end portion of the channel defined by the front volume 266 and a corresponding opening in a wall portion of the receptacle 298, the mesh 265B, extending across an open passage into the void defining the receptacle 298, as shown in FIG. 2C. In some examples, the audio output device 260 may include one, or both, of the mesh 265A shown in FIG. 2B and/or the mesh 265B shown in FIG. 2C. In some examples, the audio output device 260 may include a mesh positioned differently than shown in FIGS. 2B and 2C, at an interface between an open end portion of the channel defined by the front volume 266 and a corresponding opening in a wall portion of the receptacle 298, the mesh extending across an open passage into the void defining the receptacle 298. In some examples, the mesh 265A and/or the mesh 265B is an acoustic mesh that allows audio output signals, or sound, to pass from the channel defined by the front volume 266 and into the void defining the receptacle 298, for output via the audio output portion 268 of the combination port 200, while inhibiting the entry of debris and other foreign matter into the audio output device 260 via the combination port 200. Positioning of the mesh 265A and/or the mesh 265B at the interface between the open end portion of the channel defined by the front volume 266 and the opening into the receptacle 298 leaves the external opening into the receptacle 298 open, while still inhibiting the debris and foreign matter into the audio output device 260. Thus, in this example arrangement, ingress into the front volume 266 from the receptacle is inhibited by the mesh 265A and/or the mesh 265B. In this example arrangement, the back volume 264 is separated from the front volume 266, and from the receptacle 298, and the receptacle 298 remains open and available for insertion of a plug of an external cable.

In some examples, components of a charging device 270 are incorporated into the arm portion 130 of the example computing device 100. In some examples, the charging device 270 provides for the charging of the power storage device 120 of the example computing device 100 via the terminal receiving portion 278 of the combination port 200. In some examples, a plug of a charging cable (not shown in FIGS. 2A-3B) is removably receivable in the combination port 200, to provide for charging of the power storage device 120 of the example computing device 100 from an external power source. In particular, a plug of a charging cable may be removably received, or removably couplable, in the terminal receiving portion 278 of the receptacle 298 of the combination port 200, to provide for charging of the power storage device 120 from an external power source via the charging cable. In some examples, a plug of a data communication cable may be removably received, or removably couplable, in the terminal receiving portion 278 of the receptacle 298 of the combination port 200, to provide for the exchange of data between the example computing device 100 and an external device. In some examples, the connection of a plug of an external cable in the terminal receiving portion 278 of the receptacle 298 may provide for both charging of the power storage device 120 and for the exchange of data with an external device. In some examples, the charging function and the data communication function may be carried out separately. In some examples, the charging function and the data communication function may be carried out simultaneously in response to the coupling of a plug of an external cable in the receptacle 298.

In the example arrangement shown in FIGS. 2A-3B, at least one interface member 272 is positioned within the void defining the receptacle 298. In some examples, the at least one interface member 272 includes at least one terminal connection device (not shown in FIGS. 2A-3B) providing for an electrical connection between a plug inserted into the receptacle 298 and electronic circuitry 274 providing for charging of the power storage device 120 of the example computing device 100. In some examples, the at least one interface member 272 includes at least one connection device providing for the exchange of data between the example computing device 100 and an external device via the connection between the at least one interface member 272 and the plug received in the receptacle 298. FIGS. 3A and 3B present just one example physical configuration of the interfaces that can be incorporated into the receptacle 298 of the combination port 200, simply for purposes of discussion and illustration. The principles described herein can be applied to a receptacle of a combination port, or multi-functional port, that provides a physical interface for a charging device and/or a data communication device including interface devices configured differently than explicitly shown herein, to provide for charging of computing devices having other types of physical interfaces and/or data communication with computing devices having other types of physical interfaces.

A situation has been described above in which the user removes the example computing device 100 (configured as a head mounted wearable device, or smart glasses) for charging, so that the combination port 200 provides for charging of the example computing device 100, and the audio output device is not in operation while the example computing device 100 is not worn by the user. In some examples, the audio output device may remain operational, with output of audio content disabled through the combination port 200 of one of the two arm portions 130, and the output of audio content maintained through the audio output port of the other of the two arm portions 130 of the example computing device 100. In this manner, the example computing device 100 can continue to output audio content while also charging.

In the example arrangement described above with respect to FIGS. 2A-3B, the combination port 200 is incorporated into one of the two arm portions 130 of the example computing device 100 configured as a head mounted wearable device, or smart glasses, simply for purposes of discussion and illustration. The principles described herein can be applied to the incorporation of a combination port into other portions of the example computing device 100 configured as a head mounted wearable device, or smart glasses. For example, in some implementations, a combination port could be incorporated into the third (top) portion 133 of the arm portion 130, with the combination port sharing void space with the back volume 264 of the audio output device 260. In some examples, the principles described herein can be applied to a combination port combining the functionality of a charging port with other outward facing acoustic ports, from other acoustic channels of an audio output device of a computing device. This can include, for example, acoustic channels in addition to, or instead of, those explicitly shown and described above, such as, for example, acoustic channels providing for additional resonances not necessarily oriented toward the ear of the user and/or at a top of an arm portion of the example computing device 100 configured as a head mounted wearable device, or smart glasses. The principles described herein can be applied to the incorporation of a combination port into other portions of the example computing device 100 configured as a head mounted wearable device, or smart glasses, combining the functionality of the audio output device and the charging device, and/or other components of the example computing device 100 and/or combinations of components. The principles described herein can be applied to the incorporation of a combination port into other types of computing devices, including computing devices not explicitly shown and/or described herein.

In the example arrangement shown in FIGS. 2A-3B, the combination port 200 is incorporated into one of the two arm portions 130 of the example computing device 100, with the power storage device 120 received in the same arm portion 130 of the example computing device 100, simply for purposes of discussion and illustration. The combination port 200 can be similarly provided in the other of the two arm portions 130 of the example computing device 100. The combination port 200 and the power storage device 120 can be similarly incorporated into different arm portions 130 of the example computing device 100. The combination port 200 can be similarly incorporated into both arm portions 130 of the example computing device 100.

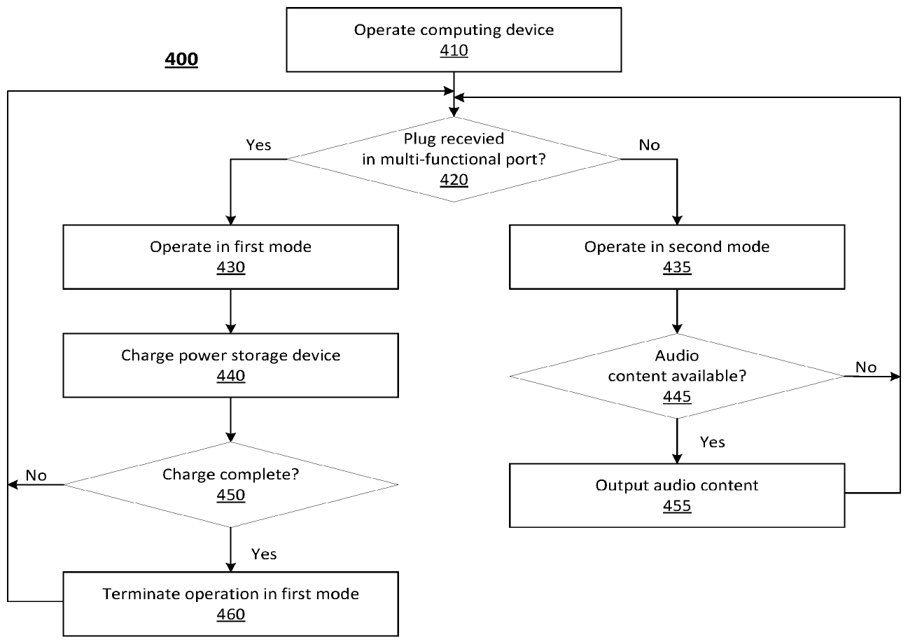

FIG. 4 is a flowchart of an example method 400, in accordance with implementations described herein. Operation of a computing device, such as one of the example computing devices 100 described above, is initiated (block 410). If a plug of an external cable is detected in a multi-functional port of the computing device (block 420), such as the example combination port 200 described above, operation in a first mode is initiated (block 430). In some examples, the first mode is a charging mode in which power is provided to a power storage device, such as the example power storage device 120 of the computing device described above, via the external cable and plug, to charge the power storage device (block 440). The computing device may continue to operate in the first mode until it is determined that charging is complete (blocks 450, 460), or until it is determined that the plug is no longer received in the multi-functional port (blocks 450, 420).

If a plug of an external cable is not detected in the multi-functional port of the computing device (blocks 420), then the computing device may operate in a second mode (block 435). In some examples, the second mode is an audio output mode in which audio signals, or audio content, generated by an audio output device, such as the example audio output device 160 of the example computing device 1100 described above, are output through the multi-functional port. If, in the second mode of operation, it is determined that audio content is generated by the audio output device and is available for output (block 445), the audio content is output via the multi-functional port (block 455). The computing device may continue to operate in the second mode until it is determined that a plug is received in the multi-functional port (block 420).

In a computing device including an audio output device and a charging device, in accordance with implementations described herein, a combination port combines functionality of the audio output device and functionality of the charging device using a shared volume. In some implementations, a front volume of the audio output device is connected to a receptacle configured to receive a plug of a charging cable, so that audio content is output via an external aperture of the receptacle when a charging plug is not inserted in the receptacle, and the receptacle is not in use for charging. In some implementations, the receptacle includes an interface device including at least one charging interface configured to connect to a corresponding charging interface of a charging plug inserted in the receptacle, for charging of a power storage device of the computing device from power provided by an external source. A combination port, in accordance with implementations described herein, assigns a dual purpose to a void space allocated for a charging receptacle with an audio output port. Generally, other dual purpose implementations are possible based on the proposed solution, for example an implementation in which the combination port is used, in a first mode, for outputting a signal without the need to have a cable connected to the combination port, whereas the combination port is used, in a second mode, for receiving signals and/or energy from cable connected to the combination port.

A number of implementations have been described. Nevertheless, it will be understood that various modifications may be made without departing from the spirit and scope of the specification. Any logic flows depicted do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A computing device, comprising:
a housing;
a port included in the housing, the port including a receptacle accessible from an outside of the housing, the receptacle including:
an audio output portion in communication with an audio driver received in the housing; and
an interface portion configured to removably receive a plug of an external cable, the interface portion including at least one interface device,
wherein
in a first mode, the audio output portion of the port is configured to output audio content generated by the audio driver; and
in a second mode, the interface portion of the port is configured to provide for at least one of:
charging of a power storage device received in the housing via the plug of the external cable received in the receptacle, or
exchange of data with an external device via the plug of the external cable received in the receptacle.

2. The computing device of claim 1, further comprising an audio output device received in the housing, the audio output device including a front volume arranged between the audio driver and the receptacle, wherein the front volume guides audio content, generated by the audio driver, to the receptacle for output via the audio output portion of the receptacle

3. The computing device of claim 2, wherein the audio output device includes a back volume coupled to the audio driver, wherein the back volume is separated from the front volume, and the back volume is separated from the receptacle.

4. The computing device of claim 2, wherein the front volume defines a channel that extends from a first side of the audio driver to the receptacle to convey audio content output by the audio driver from the audio driver, to the receptacle, and out of the computing device through the port, such that the front volume is open to the audio driver, and the front volume is open to the receptacle.

5. The computing device of claim 2, further comprising a mesh provided at an interface between an end portion of the front volume of the audio output device and an opening into the receptacle, wherein the mesh is configured to allow audio content to be output from the front volume through the receptacle, and to inhibit entry of foreign matter from the receptacle into the front volume.

6. The computing device of claim 2, wherein, in the second mode, the interface portion of the port is configured to provide for simultaneous charging of the power storage device and exchange of data with the external device.

7. The computing device of claim 2, wherein the computing device is a head mounted wearable device, and wherein the port is provided in an arm portion of a frame of the head mounted wearable device.

8. The computing device of claim 7, wherein the port includes:
an opening in a lower portion of the arm portion of the frame, the opening providing access into the receptacle; and
an opening in a wall portion of the receptacle, the opening in the wall portion of the receptacle corresponding to an open end portion of a front volume of an audio output device received in the housing,
wherein the at least one interface device is positioned in a void defined by the wall portion of the receptacle.

9. The computing device of claim 8, wherein the opening in the lower portion of the arm portion of the frame is aligned with an open end portion of the receptacle, and wherein the opening in the lower portion of the arm portion and the wall portion of the receptacle are oriented such that audio content output through the port is directed toward an ear of a user in a worn state of the head mounted wearable device.

10. The computing device of claim 7, wherein
in the first mode,
the port defines an audio output port configured to output audio content, generated by the audio output device, through the receptacle; and
operability of the port in the second mode is disabled, and
in the second mode,
the port defines at least one of a charging port configured to direct power through the at least one interface device to the power storage device received in the housing, or a data communication port configured to exchange data between a communication module received in the housing and the external device, and
operability of the port in the first mode is disabled.

11. The computing device of claim 7, wherein the head mounted wearable device includes a first arm portion and a second arm portion, and wherein
the port is provided in one of the first arm portion or the second arm portion,
the audio output device is provided in the one of the first arm portion or the second arm portion, and
the power storage device is provided in the one of the first arm portion or the second arm portion.

12. A computing device, comprising:
a housing;
a port included in the housing, the port including a receptacle accessible from an outside of the housing;
an audio output device received in the housing, the audio output device including:
an audio driver; and
a front volume arranged between the audio driver and the receptacle;
a power storage device received in the housing and connected to at least one interface device provided in the receptacle to provide for charging of the power storage device in response to coupling of a plug of an external cable to the at least one interface device; and
a data communication module received in the housing and connected to the at least one interface device in the receptacle and configured to exchange data with an external device connected to the computing device via a plug of an external cable connected between the at least one interface device in the receptacle and the external device.

13. The computing device of claim 12, wherein
in a first mode, an audio output portion of the receptacle is operable to output audio signals without connection of a cable in the receptacle, and
in a second mode, an interface portion of the receptacle is operable to receive at least one of a data signal or energy from an external source via a cable connected in the receptacle.

14. The computing device of claim 12, wherein the front volume defines a channel that extends from a first side of the audio driver into the receptacle to output audio signals from the audio driver through the port via the receptacle, such that the front volume is open to the audio driver, and the front volume is open to the receptacle.

15. The computing device of claim 12, further comprising a mesh positioned across an opening at an interface between the front volume and the receptacle, wherein the mesh allows audio signals to be output from the front volume to the receptacle, and the mesh inhibits entry of foreign matter from the receptacle into the front volume.

16. A computer implemented method, comprising:
detecting, by a sensing system of a computing device, an operating mode of the computing device;
operating in a first mode in response to detection of a plug of an external cable received in a receptacle portion of a multi-functional port of the computing device, including charging a power storage device of the computing device with power provided from an external power source via the plug received in the receptacle portion of the multi-functional port; and
operating in a second mode in response to detecting that the plug is not received in the receptacle of the multi-functional port, including outputting audio signals generated by an audio output device of the computing device via the receptacle portion of the multi-functional port.
